(19) United States
(12) Patent Application Publication
(10) Pub. No.: US 2017/0229740 A1
(43) Pub. Date: Aug. 10, 2017

(54) MULTI-ELEMENT INTERPENETRATING STRUCTURE AND ITS POSSIBLE USES FOR ELECTRICAL, ELECTRO -OPTICAL AND ELECTRO -CHEMICAL DEVICES

(71) Applicant: Alexander Preezant, Shlomi (IL)

(72) Inventor: Alexander Preezant, Shlomi (IL)

(21) Appl. No.: 15/304,862

(22) PCT Filed: Jul. 12, 2014
(86) PCT No.: PCT/IB14/63058

§ 371 Date: Oct. 18, 2016

(51) Int. Cl. H01M 10/0585; H01G 11/58; H01G 11/26; H01M 10/0525

(52) U.S. Cl. CPC H01M 10/0585; H01M 10/0525; H01G 11/58; H01G 11/26; H01M 2010/0495

(57) ABSTRACT

Details an invention of an electrical device consisting of a three-dimensional structure comprising an unlimited number of interpenetrating elements and the use of the structure in the fabrication methods for electrical, electro-optical and electro-chemical devices.

### BACKGROUND

3-D nano (in the range of 1-100 nm)/micro (in the range of 1-100 micron)/submillimeter (in the range of 100-1000 micron) structures are interesting objects of scientific and industrial research. This class includes unordered materials, such as polymer and ceramic foams, xerogels, etc., partly ordered, such as anodic alumina membranes and their replicas, and highly-ordered materials such as inverse opals and 3D micro-periodic structures fabricated by numerous methods: multi-beam interference, interference holography, two-photon polymerization, direct ink writing, freeform casting, proximity-field nano-patterning and replicas of those structures. These materials are used in applications demanding high surface area per given volume/mass or in applications utilizing their spatial structure regularity—opal and inverse-opal photonic crystals. It should be noted that 3D submillimeter structures could be fabricated by stereo-lithography, by joining prefabricated elementary units, casting and a variety of other methods that are unavailable for microstructure. These structures also possess interesting properties as will be detailed in the following.

A good example of those applications is a 3-D battery structure that has engendered considerable research efforts. The key advantage associated with the proposed 3-D battery structure is its ability to achieve large real energy capacities without sacrificing power density that may result from slow interfacial kinetics (associated with a small electrode area-to-volume ratio) or ohmic potential losses (associated with long transport distances).

The inverse-opal structure is one of the most promising possible architectures for the fabrication of a 3-D battery structures. Fabrication of the inverse-opal structure is based on the initial formation of a disposable (sacrificial) colloidal crystal composed of mono-disperse polymer or silica spheres assembled in a close-packed arrangement. The interconnected vacuoles (voids), constituting some 26% of the volume for a face-centered-cubic array, are subsequently infiltrated with the desired material.

Strategies for filling the voids of the colloidal crystal utilize sol-gel chemistry, salt precipitation, and electrodeposition, depending on the desired composition. Removal of the colloidal spheres renders a negative replica (the inverse-opal) structure of the active material, with an interconnected 3-D array of pores, typically on the order of hundreds of nanometers in size. This general procedure for producing macroporous solids has recently been exploited to synthesize electrode architectures that are targeted for lithium battery applications.

An electrochemical cell with polymer electrolyte based on the inverse-opal structure has recently been reported: cathode—metal inverse-opal structure, anode-vanadium oxide ambi-gel (“Photonic Crystal Structures as a Basis for a Three-Dimensionally Interpenetrating Electrochemical Cell”, Andreas Stein, Nicholas S. Ergang, Justin C. Lytle, Zhiyong Wang, Fan Li, William H. Smyrl, in Advanced Materials Vol. 18(13), pp. 1750-1753, 2006). In this work the 3D ordered carbon anode is prepared on a conductive substrate that acts as a current collector and the porous carbon is exposed to multiple surface modification steps to create a three-dimensionally interpenetrating cell with critical sizes on the scale of tens to hundreds of nanometers. The entire surface of the macroporous anode (except for the point of contact with the current collector) is coated with a thin, conformal layer of polyphenylene oxide by the electro-oxidative deposition of phenolic monomers. This layer acts as separator and electrolyte membrane. The remaining volume is infused with a vanadium alkoxide gel as a cathode material and a current collector attached to the cathode surface. The complete electrode structure is electrochemically lithiated and cycled a number of times. It should be emphasized that the ambi-gel cannot provide mechanical support to the whole structure which is totally supported by inverse-opal carbon structure.

There are many other technological fields where the present invention could be used. Some of these are:
A super-capacitor which is an electrochemical device comprising two porous electrodes immersed in electrolyte with a high surface area electrically separated by ion-conducting membrane. Electric energy in such devices is accumulated in so called “double layer” at the interface of electrolyte and the electrodes.
An electro-rheological devices utilizing the electro-rheological effect—a significant change of viscosity of some liquids (such as corn flour, urea coated nano-particles of barium titanium oxalate suspended in silicone oil) due to application of a high electric field (on the order of 1 kV/mm) in the small gap between two electrodes. Electro-rheological devices include hydraulic valves, clutches, brakes, shock absorbers and many others. Electro-rheological device utilizing micro-structures may allow low-voltage operation regime.
An electro-striction device utilizing the ability of some materials to shrink under application of high (5-10 kV/mm) electric fields. Those devices include mechanical manipulators, robotic “muscles”, powerful loudspeakers, etc. Electro-striction devices utilizing micro-structures may allow low-voltage operation regime
CDI—capacitive deionization (electro-sorption desalination) filters, especially MCDI—membrane capacitive deionization. MCDI is sometimes called “flow-through capacitor” technology. It is a modification of the CDI by inserting an anion-exchange membrane in front of the anode, and a cation exchange membrane in front of the cathode. In this way, the ions with the same charge sign as the electrode, the so called co-ions (e.g., the anions in the cathode), are inhibited from leaving the electrode region. This co-ion-expulsion-effect, which at low voltages negatively influences the salt adsorption rate and removal capacity in CDI, is absent in MCDI. Another advantage of MCDI is that during ion release, it is possible to use a reversed voltage which leads to a faster and more complete rejection of the counter-ions back into the flow channel. MSDI devices utilizing micro-structures may allow low-voltage operation regime and large absorbing surface area.
Electro-discharge devices is a wide class of devices utilizing mechanical and mechanical-chemical processes occurring in plasma produced at electric discharge between electrodes under sufficiently high applied voltage. This class includes radiation detectors utilizing gas electric breakdown under irradiation, plasma sources and chemical reactors utilizing molecular activation by dissociation in high field region in the inter-electrode gap, gaseous laser utilizing electric discharge for energy pumping, light sources utilizing optical radiation of gas discharge plasma. Electro-discharge devices utilizing micro-structures may allow low-voltage operation regime.
Free-electron lasers (FEL) with longitudinal modulation of electrostatic field. FELs are radiation sources based on periodic disturbance of trajectory and/or velocity of relativistic electrons. Periodic disturbance cause periodic oscillation in electron-induced field manifesting itself in coherent radiation. FEL is an important source of teraherz radiation. Most of the FELs belong to so called “wigglers”, utilizing the electron's transversal oscillation under the influence of the spatially-periodic structure of magnetic dipoles. Here there are several patents (U.S. Pat. No. 4,367,551 and U.S. Pat. No. 4,864,575) describing the possibility of using the modulation of the electron's longitudinal velocity under the influence of the spatially-periodic electric field produced by an anode-cathode manifold under applied voltage. FEL utilizing 3D ordered interpenetrating micro-structures may produce whole-volume high-power super-teraherz or petaherz radiation.
Tunable photonic crystal is a 3D ordered structure, such as inverse-opals made of optically transparent conductive materials, for example, conducting oxides, with an optical wave-length on the order of 100-10.000 nm, filled with electro-active optical materials (electro-refractive/liquid crystal material). Due to light wave interference on the photonic crystals structure, manipulation of light (reflection, guiding, refraction, etc.) is made possible. Under application of the electric potential, the electro-active filler changes its optical properties causing controllable changes in light-structure interaction. Tunable photonic crystal utilizing 3D ordered interpenetrating micro-structures may allow low-voltage operation regime.

### BRIEF DESCRIPTION OF THE INVENTION

The main purpose of the invention is to provide a comprehensive fabrication path of three-dimensional interpenetrating multiple-element ordered structure comprising two or more separated self-supporting elements, where all the elements are whole-volume connected spatial structures in and of themselves. The main idea of this method is the deposition of the next structure's element into a voids defined by disposable (sacrificial) layers deposited on the existing structure's elements. Possible applications of those structures are discussed.

### FIGURES

FIG. 1 Illustrative schematic description of two-element ordered interpenetrating three-dimensional structure

FIG. 2 Illustrative detailed description of two-element ordered interpenetrating three-dimensional structure

### DETAILED DESCRIPTION OF THE FABRICATION

The fabrication path described below could be applied to any three-dimensional open-pore porous structure without any limitation: ordered or disordered, with characteristic pore sizes on spatial scale from tens of nanometers up to any desirable spatial scale.

The following is a specific example the fabrication path we propose utilizing inverse-opal structure as very useful for nano/micro-scale:

The fabrication of inverse-opal structure starts with a primary disposable structure formed by a colloidal solution of latex or polystyrene mono-disperse spheres deposited on a conducting substrate (as described elsewhere). The sphere diameters may vary over a wide range from several microns up to hundreds microns depending on application's demands. In the next stage the voids between the spheres are filled by means of the electrodeposition of metals or conducting oxides, such as ZnO, or by pressure casting of a low-melting-point alloy (LMPA), such as Roos alloy, Wood's alloy or other bismuth-containing alloy. After which the latex spheres are dissolved by suitable solvents. What remains is an inverse-opal structure comprising the first component of multiple-element interpenetrating structure.

The inverse-opal structure fabricated in the previous stage may be partly etched out to produce a lighter structure. The surface of the structure could be covered with another metal, such as Zn, Cu, Ag, by electro- or electroless-deposition.

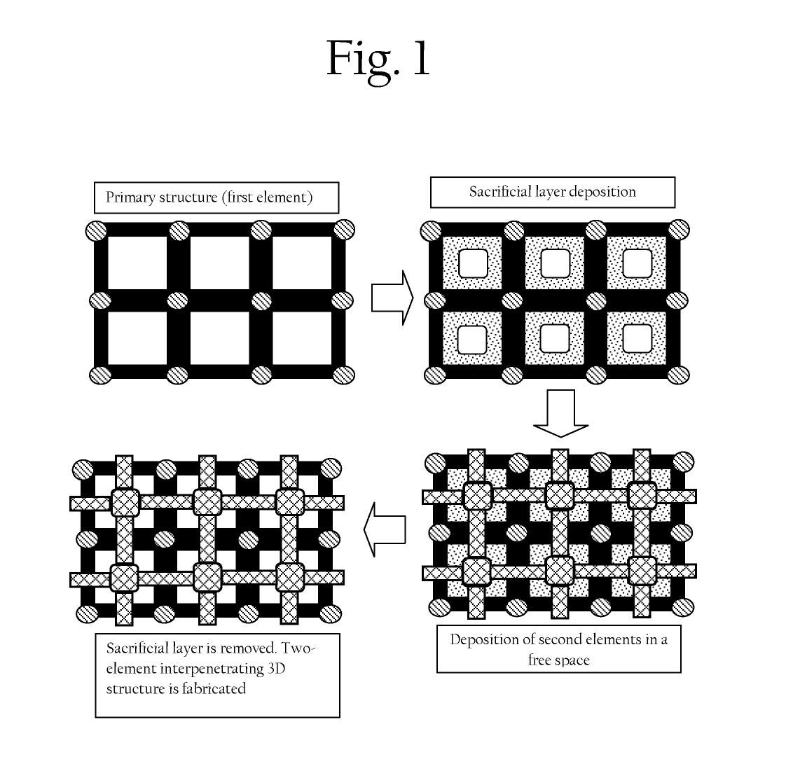

The fabrication process of the second element of the structure is schematically illustrated in FIG. 1. In order to produce the second component of the structure the primary inverse-opal structure should be covered with soluble disposable polymer material such as PDMA (poly(2,5-dimethoxyaniline)) that could be fabricated by electrodeposition forming the conformal layer with homogeneous thicknesses of up to ˜10 micron or PVDF (Polyvinylidene fluoride) that could be deposited electrophoretically with homogeneous thicknesses of up to ˜100 micron. Polymer dip-coating could be used for structures with larger characteristic pore sizes. Electrochemical polymerization of PDMA could be performed from a DMA monomer solution in 1M LiClO₄-propilene carbonate by a sweeping potential in the range of −0.2 V to 1.6 V with a sweep rate of 50 mV/s. The thin PVDF layer could be deposited electrophoretically from acetone solution of the polymer in constant current mode with current density of ˜150 microA/cm² (120-200 V) and annealed. Thick films of PVDF could be deposited from isopropanols suspension of ultrasonically dispersed 0.2 micron polymer particles. During electro-phoretic deposition, a porous film forms that could be made denser by repeated cycles of annealing at 140-180° C. and subsequent electrophoretic deposition to fill the cracks.

In order to fabricate a light but robust second structure element, the disposable layer should be deposited in such manner that almost all the free space is filled but still allows material deposition, creating a continuous piece of material connected throughout the space in the remaining voids.

The second component of the structure is produced by filling the voids remaining after covering the first component with the disposable polymer layer. As before, the filling is carried out by the electrodeposition of metal or conducting oxides, such as ZnO, or by pressure casting of a low-melting-point alloy (LMPA). In order to keep both elements of the structure in a static/controllable relative spatial position, both elements have to be mounted on at least one rigid external support (handler) for each element. The supports could be attached to the structure's elements at a few points while still providing the possibility of controlling and manipulating the spatial position of the element. In the case of electrodeposition, a second conducting substrate must be provided. After the deposition of the second component, the disposable layer is dissolved, in an appropriate solvent, leaving unfilled space between the first and the second components of the multiple-element interpenetrating structure.

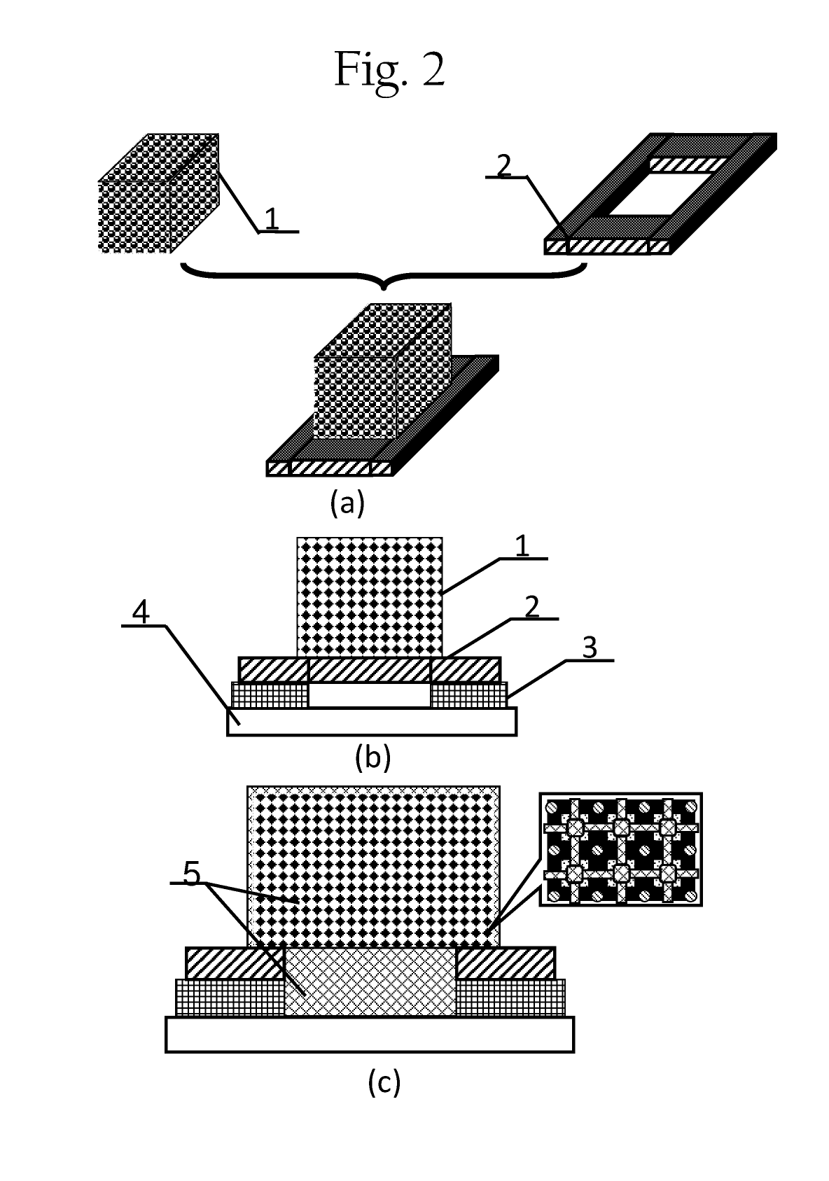

Here we provide more detailed description of fabrication path in order to facilitate an understanding of sophisticated aspects. As already said we start from primary porous structure made of conducting material. The piece of the primary structure should be connected (soldered) to first mechanical support (which could be insulating or conducting to serve as current conductor) as shown on the FIG. 2 (a). The piece of primary porous structure (1) mounted on first mechanical support (2) is subjected to sacrificial layer deposition allowing subsequent deposition of the secondary structure.

In order to fabricate the secondary structure penetrating the voids of the primary structure (1) we mount the first mechanical support (2) with the piece of the primary structure (both of them are already covered with sacrificial polymer layer) onto the second mechanical support (4) using insulating separators (3) as shown on the FIG. 2 (b). The resulting setup is immersed in an electro-deposition bath when the second mechanical support (4) serves as electrode for electro-deposition of secondary structure (5). Finally, we should get the structure consists of two mutually-interpenetrating mechanically robust grids when each one of them is connected to separate mechanical support as shown on the FIG. 2 (c)

Structures in the sub-millimeter range and above could be produced by more conventional fabrication methods. For example, on the scales of 0.1-1 mm one can use well-established stereo-lithographic or 3D sintering techniques to produce the first structure's element. After this the obvious dip-coating technique can be used to produce the disposable layer on the first element and finally the second element could be fabricated by casting or using the sol-gel deposition method.

Two-element interpenetrating 3D structures obtained as described above could be utilized for further fabrication of multi-element structure in the following manner. For the fabrication of a three-element structure both elements have to be covered by a conformal layer of disposable polymer. The polymer layers have to be separated by a gap to allow the filling of the third element by pressure/vacuum slip casting, sol-gel filling, electrodeposition or chemical bath deposition into the free space between the polymer layers. Dissolution or burning/etching out of the disposable polymer layers leaves the three-element structure.

A four-element structure could be fabricated as follows: both elements of the two-element structure have to be covered by disposable conformal layers of electrodeposited conductive polymer. On the top of both conductive polymer layers another conductive material, such as metal or conductive oxide, has to be deposited by electrodeposition resulting in third and forth structure elements, respectively.

A five-element structure could be fabricated from a four-element one by covering the inner surfaces of the third and forth elements by disposable conformal layers of electrodeposited conductive polymer and filling the space between the polymer layers by additional material fully analogously to the fabrication of the third element in three-element structure.

In general there is no theoretical limitation to number of elements that can be fabricated this way. In all cases of multiple-element structures, all the structure's elements must be mounted on at least one external support (handler) for each element, in order to keep all the elements of the structure in static/controllable relative spatial positions. The supports need only be attached to the structure's elements at a few points and still provide the possibility of controlling and manipulating the spatial position of the element.

The double interpenetrating structure thus obtained can immediately serve as part of any electro-discharge device like those mentioned above. The two elements of the structure made of conducting materials serve as two electrodes with a spark gap between them. For devices with silent electric discharge the surface of one of the electrodes or the surface of both of them should be covered with insulating layer. We suggest using an electrophoretically deposited sol-gel derived silica. An example of the fabrication process is as follows:

We begin with an initial silica (SiO2) sol consisting of tetraethylorthosilicate (TEOS), de-ionized water (DI-H2O), ethanol (EtOH), and hydrochloric acid (HCl). (Hereafter, we will refer to this initial SiO2 sol as ‘TEOS’.) This is placed in a 50 ml beaker containing a stir bar, and 3 nil of DI-H₂O is added with 8 ml of EtOH. This mixture is stirred at 500 RPM for 5 min at room temperature. We then add 21 ml of TEOS and 0.09 ml of HCl to the solution while stirring. The solution is then allowed to stir at 500 RPM for 2 hours at room temperature. The deposition of SiO2 film onto Si wafer is initiated by the use of sol electrophoretic deposition (EPD). Before deposition, various amounts of EtOH is added to the TEOS solution to obtain a diluted sols with an EtOH:TEOS volume ratio of 10:1. An additional amount of ammonium hydroxide (NH₄OH) is added to the sol to increase the pH above 2.2 to a pH value of between 3 and 4. Titanium plate is then used as the counter-electrode and one of the structure's elements is a working electrode. Appropriate voltage is then applied between the electrodes to perform electrophoretic deposition. After deposition, the deposited silica films are dried at 100° C. for 1 hour and annealed at several hundreds of degrees Celsius.

The double interpenetrating structure thus obtained comprises conducting elements that can be used immediately for fabrication of electro-strictive devices. The space between the electrodes has to be filled by electro-strictive material and appropriately cured. An example of electro-strictive material is a PVDF-TrFE (poly(vinylidenefluoride-co-trifluoroethylene) co-polymer deposited from organic solvent solution with the addition of organic peroxides cross-linking agents (more than 10% striction under an 0.8 MV/cm applied field). The cross-linking agent may include at least one of the following: dicumyl peroxide (DCP), benzoyl peroxide, bisphenol A, methylenediamine, ethylenediamine (EDA), N-isopropyl ethylenediamine (IEDA), 1,3-Phenylenediamine (PDA), 1,5-Naphthalenediamine (NDA), and 2,4,4-trimethyl-1,6-hexanediamine (THDA). The polymer has to be dried and cured for 40 min at 130° C.

Also the double interpenetrating structure thus obtained could be used immediately for the fabrication of electro-chemical cell (battery). If each one of the structure's components consists of different metals or metal oxides, the battery fabrication could be accomplished by filling the inter-component space by electrolyte. If the components, or one of the components, is made of LMPA, its surface must be covered by an appropriate metal (by electro-deposition, for example) prior to filling with electrolyte. For example, in the fabrication of a Zn/AgO battery, Zn is electro-deposited on the structure's elements from a 0.5 M ZnCl2, 25 g/l H3BO3 aqueous solution by using cyclic voltametric and potentiostatic techniques. After this, Ag₂O is electrodeposited on the counterpart element directly from aqueous solutions of 50 mM silver acetate/25 mM sodium acetate at pH of 6-7. Fabrication is accomplished filling inter-electrode space by an alkaline (NaOH or KOH) electrolyte.

What follows is a detailed description of an even more sophisticated Li-ion battery fabrication. The cathode and anode materials are LiMn₂O₄ and Li₄Ti₅O₁₂, respectively. Both of them may be prepared by the sol-gel method. Battery fabrication starts with a two-element inverse-opal interpenetrating structure made of Pt, or LMPA covered with an electrodeposited layer of Pt. One element of the structure will be cathode-supporting element. In the next stage the PDMA or PVDF disposable polymer layer is deposited on the surface of one of the elements in a manner retaining the voids between the polymer layer and the second element. For the preparation of the LiMn₂O₄ solution one can choose manganese (III) acetylacetonate [Mn(CH₃COCHCOCH₃)₃] and lithium acetylacetonate [Li(CH₃COCHCOCH₃)], which do not contain water, as solutes, and a mixture of 1-butanol and acetic acid as solvents. The solution for the thin film deposition is made by mixing the precursors, and the solvents. Each precursor concentration is controlled to adjust the ratio of Li:Mn=1:2. The solution (0.4M) has to be stirred with a magnetic stirrer for 10 hours, and passed through a 0.2 μm filter prior to use. In the next step the solution is deposited in the voids between the polymer layer and the second (uncovered) structure element dried at 400° C. for 30 min to remove the polymer layer and annealed at 700° C.

The Li₄Ti₅O₁₂ anode could be prepared by an analogous method. After deposition of the disposable polymer layer on the freshly prepared cathode in the previous stage, the solution for the voids between the polymer and the counterpart structure element uncovered with polymer of the anode preparation are filled. The solution precursor materials are lithium acetylacetonate [Li(C₅H₈O₂)] (97% purity) and titanium(IV) butoxide [Ti[O(CH2)₃CH₃]₄] (99% purity). The concentration of each precursor is controlled to adjust the ratio of Li:Ti to 4:5. 1-Butanol and acetic acid are used as solvents. The precursors have to be stirred with a magnetic stirrer for 20 min with 1-butanol, and stirred for an additional 3 hours after adding the same volume of acetic acid. The concentration of the solution is controlled to be 0.05 M. The solution then is passed through a 0.2 μm filter prior to use. After the solution deposition, it has to be dried at 400° C. for 30 min to remove the polymer layer and annealed at 600° C.

If electrodeposition of the polymer disposable layer on the surface of the freshly prepared cathode as described above is impossible for some reasons, we suggest another, more universal method of anode fabrication. After the cathode deposition, we suggest to deposit on the anode-supporting element a two-layered disposable layer:soluble polymer could be electrodeposited on the anode-supporting element and covered by an insoluble electrodeposited polymer such as PPy (poly-pyrolle) or covered by casting of solution-processing polymer that is insoluble in organic solvents such as water-soluble PVA (poly[vinyl alcohol]). After the deposition of the second (insoluble) layer, the soluble layer underneath should be washed out to open the space for anode material deposition as described above. The second layer should be washed out by an appropriate solvent (water in the case of PVA) or burned out in the case of PPy.

Li-ion electrolyte (LiClO₄ solution in ethylene carbonate) will serve in the battery fabrication.

A two-element structure could be utilized for fabrication of additional electrochemical devices, such as the super-capacitor mentioned above. Fabrication starts from two-element interpenetrating 3D structure with both conductive elements. Porous electrodes consisting of CNT (carbon nano-tube) and electro-polymerizable insoluble polymer such as PPy (poly-pyrrolle) or PANI (poly-aniline) and their derivatives could be fabricated by co-electrodeposition on both existing structure elements. Co-electrodeposition of the PPy-CNT composite films was carried out in an aqueous solution of 0.1 mol/1 pyrrole monomere+10 mg/l CNTs. After the deposition of the porous electrodes the separator could be made from blends of PVDF-HFP (poly [vinylidene fluoride-co-hexafluoropropylene]) and PS (polystyrene) were microporous when cast from solvent/non-solvent mixtures of acetone/dimethylcarbonate (DMC)/butanol (BuOH), where BuOH was the non-solvent for both polymers. The ionic conductivities of these separators reached 2 mScm⁻¹ and could be increased to 4 mScm⁻¹ with the addition of fumed silica. Fabrication may be accomplished by soaking with electrolyte such as LiPF₆ solution in ethylene carbonate/DMC/diethyl carbonate

A two-element structure could be utilized for fabrication of additional electrochemical devices, such as the membrane capacitive deionization (MCDI) mentioned above. The fabrication starts from a two-element structure with both elements made of conducting material metals, conducting oxides, etc. that are compatible with carbonization temperatures (˜1000° C.) and rigid enough to provide support to the structure. Both elements are covered by electrodeposited PPy layers leaving enough space between the layer for further fabrication and operational purposes of the device. PPy layers pass carbonization in an Argon atmosphere at 1000° C. resulting in a porous carbon structure. Additional ion-exchange polymer membrane layer should be deposited on each one of the carbon-covered element. We suggest using electrodeposited PPy modified by appropriate cation- and anion-exchange moieties. For the anion-exchange membrane the following materials could be used: perchlorate ion—ClO4. For the cation-exchange membrane the following materials could be used: p-toluene-sulfonic acid (TSO). Polymer coating for anion extraction is fabricated by electrochemical polymerisation of pyrrole carried out in a Nitrogen-purged aqueous solution containing 0.05 M pyrrole and 0.1 M lithium perchlorate. A constant deposition potential of +0.8 V is then applied for 20 min followed by an anodic sweep, at a scan rate of 100 mV s21, to 21.0 V. The latter potential should be maintained for 2 min After electro-polymerisation, the polymer-coated working electrode should be rinsed with Milli-Q water and dried under nitrogen. Polymer coating for cation extraction is prepared employing a solution containing 0.1 M pyrrole and 0.5 M TSO and at a constant potential of +0.8 V for 20 min. The polymer coated working electrode should be rinsed with Milli-Q water and dried under nitrogen. Both PPy layers with ion-exchange additives should be electrodeposited leaving enough space between the layers for further operational purposes of the device which means liquid flow.

The multiple-element interpenetrating structure could be also used for the fabrication of electrochemical fuel cell. The following are possible routes for the fabrication of the polymer-electrolyte fuel cell and of the solid-oxide fuel cell (SOFC).

Fabrication of polymer-electrolyte fuel cell starts from a double interpenetrating structure with both components made of LMPA. On the surface of both components a disposable conducting polymer (PDMA) layer is deposited as described before. An electrodeposited two-component alloy comprising of more and less noble component such as Ni—Cu or Pt—Co or Ag—Au should be on the top of the conducting polymer layer. After the deposition, the alloy has to be etched for selective dissolution of the less noble component retaining the nano-porous structure of the nobler one. The space between the nano-porous electrodes fabricated as described below will be filled with polymer electrolyte membrane (PEM). Melting down the LMPA will open the space for the fuel and oxidizer supply.

The following is an example of the path for preparing the polymer electrolyte membrane (PEM). The PVdF-HFP copolymer is dissolved in the mixture of 6.5 ml of acetone (pure POCH) and 1.12 ml of 1-butanol (pure POCH). After 15 min of intensive stirring, the solution is cast into the inter-electrode space. This results in obtaining a self-standing sponge of good flexibility. The membrane thus obtained is dried under vacuum to remove residual water, acetone and 1-butanol. The sponge should be soaked with electrolyte precursors using the excess of the water solutions containing the monomer, a thermal free-radical initiator (sodium persulfate, Na₂S₂O₈, pure p.a. POCH) and (when used) a cross-linking agent (bisacrylamide, BAA, purum, ≧98.0%). The monomers could be: sodium p-styrenesulfonate (SSNa hydrate), sodium p-vinylsulfonate (VSNa, 25 wt. % in H2O, technical grade), methacrylic acid (MAA, purum) and acrylic acid (AA, purum, anhydrous, 99.0%)—taken in appropriate proportions. The reagents will reacts under heating to 80-90° C.

Preparation of the SOFC also starts from a double interpenetrating structure with both components made of LMPA covered with an additional layer of metal with a higher melting point compatible with ceramic annealing temperatures but easily electro-dissoluble such as Pt or Ni. On the surface of both components a disposable conducting polymer layer is deposited as described before. Now the space between the polymer layers should be filled with sol-gel precursor of a solid state electrolyte such as yttria-stabilized zirconia (YSZ). The precursor should be dried at the temperature of several hundred degrees Celsius sufficient for the polymer removal but not such as to melt the metal under the polymer layer. The spaces between the metal leafs and the solid state electrolyte will be filled with sol-gel precursor of anodic material such as NiO/YSZ from one side and sol-gel precursor of cathodic material such as La₂Ni₄₊ₓ. Finally, a three-layered structure should be annealed. The metal leafs will be electro-dissolved after the annealing leaving the space for fuel and oxidizer supply.

1: A three-dimensional interpenetrating multiple-element, ordered or unordered, structure consisting of two or more spatially separated mutually-interpenetrating elements, where all the said elements are whole-volume connected spatial structure by itself and each element is mounted on at least one external mechanical support (handler). Those supports could be attached to the elements at several points providing the possibility of controlling and manipulating the spatial position of the element

2: The fabrication method for said structure is based on consequent deposition of the next structure's element into a voids defined by the disposable layers deposited on the existing structure's elements mounted on external mechanical supports (handlers). The next structure element is connected to its own mechanical support (handler) during or after its deposition process and is released by subsequent removal of disposable layers.
